(19) United States
(12) Patent Application Publication
(10) Pub. No.: US 2017/0121911 A1
(43) Pub. Date: May 4, 2017

(54) TISSUE SOFTNESS BY WATERLESS CHEMISTRY APPLICATION AND PROCESSES THEREOF

(71) Applicant: Georgia-Pacific Consumer Products LP, Atlanta, GA (US)

(72) Inventors: Farminder S. Anand, Painesville, OH (US); Phuong V. Luu, Ellenton, FL (US); Taiye Philips Oriaran, Appleton, WI (US); David W. White, Clintonville, WI (US); Dean J. Baumgartner, Bonduel, WI (US); Greg A. Wendt, Neenah, WI (US); Tianyan Hartlep, Appleton, WI (US); Cynthia G. Brinkley, Neenah, WI (US); Brian S. Hammes, Appleton, WI (US)

(21) Appl. No.: 15/341,509

(22) Filed: Nov. 2, 2016

Related U.S. Application Data
(60) Provisional application No. 62/250,547, filed on Nov. 4, 2015.

(51) Int. Cl. D21H 27/00; B05D 1/02; B05D 1/28; D21H 19/14

(52) U.S. Cl. CPC D21H 27/002; D21H 19/14; B05D 1/02; B05D 1/28

(57) ABSTRACT

A tissue softener comprising a softening agent and a viscosity modifying agent, having a viscosity of at least 100 centipoise (cP), and being substantially water-free.

### CROSS REFERENCE TO RELATED APPLICATION

This application is based on U.S. Provisional Patent Application No. 62/250,547, filed Nov. 4, 2015, which is incorporated herein in its entirety.

### BACKGROUND OF THE INVENTION

The present invention is directed generally to tissue products. More specifically, the present invention is related to tissue softeners.

The commercial tissue industry uses a variety of approaches to increase softness of tissue products, such as bath tissues, facial tissues, towels, wipes, and napkins. For example, various functional chemistries, called chemical or tissue softeners, can be applied to the sheets either in the wet-end of the system (before drying) or the dry-end of the system (after drying).

However, using chemical softeners can have drawbacks. First, the water associated with water emulsions in chemical softener formulations can reduce the web's adhesion to a Yankee dryer, resulting in inefficient production speed and drying. Second, chemical softeners can reduce a tissue's tensile strength, which is disfavored in the final commercial product. Third, applying a water-emulsion based chemical softener can increase the energy input necessary to dry a tissue, which can increase production time and cost.

Based on the foregoing, there still exists a need for a tissue softener that minimizes interference with adhesion to a Yankee dryer, maintains a tissue's tensile strength, and increases production efficiency. Accordingly, it is to solving this and other needs the present invention is directed.

### SUMMARY OF THE INVENTION

The present disclosure is directed to tissue softeners, methods of making tissue softeners, and methods of making tissues using the tissue softeners. In one aspect, a tissue softener includes a softening agent and a viscosity modifying agent, has a viscosity of at least 100 centipoise (cP), and is substantially water-free.

In another aspect, a method making a tissue includes depositing a tissue softener directly onto a surface of a substrate comprising cellulosic fibers. The tissue softener includes a softening agent and a viscosity modifying agent, has a viscosity of at least 100 cP, and is substantially water-free.

Yet, in another aspect, a method of making a tissue includes depositing a tissue softener onto a wet surface of a substrate comprising cellulosic fibers. The tissue softener includes a softening agent and a viscosity modifying agent, has a viscosity of at least 100 cP, and is substantially water-free.

Still yet, in another aspect, a method of making a tissue includes depositing a tissue softener onto a surface and transferring a substrate comprising cellulosic fibers onto the tissue softener on the surface. The tissue softener includes a softening agent and a viscosity modifying agent, has a viscosity of at least 100 cP, and is substantially water-free.

It is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the present invention. It is important, therefore, that the claims be regarded as including such equivalent constructions insofar as they do not depart from the spirit and scope of the present invention.

Other advantages and capabilities of the invention will become apparent from the following description taken in conjunction with the examples showing aspects of the present invention.

### BRIEF DESCRIPTION OF THE DRAWINGS

The invention will be better understood and the above object as well as other objects other than those set forth above will become apparent when consideration is given to the following detailed description thereof. Such description makes reference to the annexed drawing wherein:

FIGS. 1A and 1B are schematic illustrations of waterless spray tissue softener applications with air atomizing nozzles.

FIG. 2 is a graph of tissue Sensory Softness (SS) as a function of Geometric Mean Tensile (GMT).

FIG. 3 is a graph of tissue SS as a function of spray softener applied.

FIG. 4 is a graph showing refining energy [Horsepower Days/Ton (HP Days/Ton)] for undiluted and diluted softeners.

FIG. 5A is a graph showing a softening agent's viscosity (cP) as a function of % solids.

FIG. 5B is a graph showing a softening agent's viscosity (cP) as a function of % solids.

FIG. 5C is a graph showing a softening agent and viscosity modifying agent mixture's viscosity (cP) as a function of % solids.

### DETAILED DESCRIPTION OF THE INVENTION

For a fuller understanding of the nature and desired objects of this invention, reference should be made to the above and following detailed description taken in connection with the accompanying figures. When reference is made to the figures, like reference numerals designate corresponding parts throughout the several figures.

The present disclosure is directed to softener compositions for imparting softness to a tissue. In one aspect, a tissue softener includes a softening agent and a viscosity modifying agent, has a viscosity of at least 100 cP, and is substantially water-free.

In another aspect, a method making a tissue includes depositing a tissue softener directly onto a surface of a substrate comprising cellulosic fibers. The tissue softener includes a softening agent and a viscosity modifying agent, has a viscosity of at least 100 cP, and is substantially water-free.

Yet, in another aspect, a method of making a tissue includes depositing a tissue softener onto a wet surface of a substrate comprising cellulosic fibers. The tissue softener includes a softening agent and a viscosity modifying agent, has a viscosity of at least 100 cP, and is substantially water-free.

Still yet, in another aspect, a method of making a tissue includes depositing a tissue softener onto a surface and transferring a substrate comprising cellulosic fibers onto the tissue softener on the surface. The tissue softener includes a softening agent and a viscosity modifying agent, has a viscosity of at least 100 cP, and is substantially water-free.

As used herein, the term “cellulosic” means fibers or products incorporating papermaking fibers having cellulose as a major constituent. Suitable papermaking fibers include those derived from non-recycled paper sources, as well as secondary, recycled paper sources.

As used herein, the terms “by weight,” “% by weight,” and “wt. %” mean weight of a substance divided by the total weight of the composition, whichever is indicated. Weight can be measured in grams (g).

Tensile strength of tissue produced in accordance with the present invention is measured in the machine direction (MD) and cross-machine direction (CD) on an Instron Model 4000: Series IX tensile tester with the gauge length set to 3 inches. The area of tissue tested is assumed to be 3 inches wide by 3 inches long (the distance between the grips). In practice, the length of the samples is the distance between lines of perforation in the case of machine direction tensile strength and the width of the sample is the width of the roll in the case of cross-machine direction tensile strength. A 20 pound load cell with heavyweight grips applied to the total width of the sample is employed. The maximum load is recorded for each direction. The results are reported in units of “grams per 3-inch”; a more complete rendering of the units would be “grams per 3-inch by 3-inch strip”. GMT (geometric mean tensile) is calculated by taking geometric mean of the tensile strength measured along the MD and CD.

Sensory softness of the samples was determined by using a panel of trained human subjects in a test areas conditioned to TAPPI standards (temperature of 71.2° F. to 74.8° F., relative humidity of 48% to 52%). The softness evaluation relied on a series of physical references with predetermined softness values that were always available to each trained subject as they conducted the testing. The trained subjects directly compared test samples to the physical references to determine softness level of the test samples. The trained subjects assigned a number to a particular paper product, with a higher sensory softness number indicating a higher perceived softness.

As used herein, the term “viscosity” refers to a fluid's thickness or resistance to gradual deformation by shear stress or tensile stress. Viscosity can be recited in units of centipoise (cP). Methods for determining viscosity are discussed in detail below.

As used herein, the term “substantially water-free” when used in reference to the tissue softener means having a water content of less than about 10 wt. % based on the total weight of the tissue softener. In one aspect, substantially water-free means having a water content of less than 5 wt. % based on the total weight of the tissue softener. In another aspect, substantially water-free means having a water content of less than 3 wt. % based on the total weight of the tissue softener. Yet, in another aspect, substantially water-free means having a water content of less than 2 wt. % based on the total weight of the tissue softener. Yet still, in another aspect, substantially water-free means having a water content of less than 1 wt. % based on the total weight of the tissue softener.

As used herein, the term “tissue” includes a towel, a napkin, a facial tissue, and the like.

The tissue softener includes a softening agent. The softening agent is a non-ionic compound, a cationic compound, a silicone compound, or any combination thereof. The softening agent is present in the tissue softener in amount in a range between about 10 and about 95 wt. % based on the total weight of the tissue softener. In one aspect, softening agent is present in the tissue softener in amount in a range between about 20 and about 80 wt. % based on the total weight of tissue softener. In another aspect, the softening agent is present in the tissue softener in amount in a range between about 30 and about 70 wt. % based on the total weight of the tissue softener. Still yet, in another aspect, softening agent is present in the tissue softener about or in any range between about 10, 15, 20, 25, 30, 35, 40, 45, 50, 55, 60, 65, 70, 75, 80, 85, 90, and 95 wt. % based on the total weight of the tissue softener.

Non-limiting examples of suitable non-ionic compounds for the softening agent include natural wax (e.g., candelilla wax, beeswax, polyglyceryl-3-beeswax, carnauba wax, paraffin wax, and cerasin wax), stearyl heptanoate (commercially available as TEGOSOFT SH from Evonik Industries, Essen, Germany), sucrose cocoate, shea butter, cetyl ricinoleate, PEG-30 glyceryl cocoate, mixtures of sorbitan oleates and ethoxylated alkyl amines (commercially available as Softener PA-A from RCI Technology, Inc., Charlotte, N.C.).

Non-limiting examples of suitable cationic compounds for the softening agent include quaternary ammonium compounds, e.g., dialkyldimethyl ammonium chloride, di(palm-oil-alkyl) dimethyl ammonium chloride, tricaprylmethyl ammonium chloride, benzyl C₁₂-C₁₆ dimethyl ammonium chloride, tricetyl methyl ammonium chloride, dimethyl di (C₁₄-Cis alkyl) ammonium methyl sulfate, and distearyl dimethyl ammonium chloride (commercially available as VARISOFT TA 100 from Evonik Industries); ester functional quaternary compounds, e.g., methyl triethanol ammonium methyl sulfate distearyl ester, palmitic amidopropyl trimethyl ammonium chloride, and methyl-2-hydroxyethyl bis-(2 hydroxyethyl) ester with C₁₄-C₁₈ unsaturated fatty acid ammonium methyl sulfate; imidazoline/imidazolinium compounds, e.g., isostearyl hydroxyethyl imidazoline, oleyl hydroxyethyl imidazoline, 2-methyl-2-imidazoline, dioleyl imidazolinium, methyl-1-oleylamido ethyl-2-oleyl imidazolinium methyl sulfate, 2-(C₁₇and C₁₇ unsaturated alkyl)-1-[2-(C₁₈ and C₁₈ unsaturated amido) ethyl]-4,5-dihydro-1-methylimidazolinium methyl sulfate (commercially available as VARISOFT 3690 from Evonik Industries), 1-ethyl-2-noroleyl-3-oleyl amido ethylimidazolinium ethyl sulfate (commercially available as VARISOFT 3696 from Evonik Industries), and a mixture of an imidazolinium compound and anionic silicone (commercially available as VARISOFT GP B 100 from Evonik Industries); or any combination thereof.

Non-limiting examples of suitable silicone compounds for the softening agent include non-ionic silicone compounds, e.g., silicone wax, cetyl dimethicone, stearyl dimethicone, behenoxy dimethicone, stearoxy dimethicone, phenyl silicone, phenyl trimethicone, low molecular weight polydimethylsiloxane, high molecular weight polydimethylsiloxane, polyether trisiloxane, amino functional polydimethylsiloxane, aminopropyl dimethicone, cyclopentasiloxane, trimethylsiloxy polysilicate, polyether alkyl polymethyl siloxane, cyclomethicone, C₂-C₃₂ alkylated silicones (commercially available as SILWAX DO2 and SILWAX J1016 from Siltech Corporation), aryl siloxane (commercially available as SILWAX DO-MS from Siltech Corporation), alkyl aryl siloxane (commercially available as SILWAX 3H2-MS from Siltech Corporation), silicone multi-ester (commercially available as SILUBE TMP Di-10, SILUBE TMP Di1018 from Siltech Corporation). The softening agent can be a cationic silicone compound, e.g., silicone quaternium-22 (commercially available as Abil® T Quat 60 from Evonik Industries), quaternary polydimethylsiloxane (commercially available as Silquat J15 and Silquat J2-B from Siltech Corporation, Ontario, Canada), silicone fatty amido quats (commercially available as Silquat D208-CDA and Silquat D208-TDA from Siltech Corporation), silicone polyether fatty quats (commercially available as Silquat AD or Silquat AC from Siltech Corporation), tertiary amines based on morpholine (commercially available as Silamine D10-M from Siltech Corporation), tertiary amines based on ethanolamines (commercially available as Silamine D10-D from Siltech Industries), or any combination thereof. Other non-limiting exemplary silicone compounds for the softening agent include dimethicone copolyols, such as commercially available SILSURF A008-UP, C208, J208, and D212-CG from Siltech Corporation; silicone dialkyl quats (linear or multiple), such as commercially available SILQUAT AO, D2-B, J208-1B, and J2B from Siltech Corporation; silicone amines (primary, secondary and tertiary amines, such as commercially available SILAMINE Di-50-D from Siltech Corporation), quaternary polydimethylsiloxane (commercially available as SILQUAT J15 from Siltech Corporation); silicone polyether fatty quats (commercially available as SILQUAT AD from Siltech Corporation); silicone coco monoamide quats (commercially available as SILQUAT D208-CA from Siltech Corporation); silicone coco diamide quats; silicone phosphates, such as commercially available as SILPHOS A-100, and J208 from Siltech Corporation, and dimethicone PEG-8-phosphate (commercially available as SILSENSE PE-100 Silicone from Lubrizol Corporation, Wickliffe, Ohio); silicone polyether ester and carboxylates based on fatty acids such as lauric acid and isostearic acid (commercially available as SILWAX WD-IS from Siltech Corporation); polydimethylsiloxane copolyol succinate (commercially available as SILUBE CS-I from Siltech Corporation); complexes of silicone quaternary compound and anionic silicone compounds, such as silicone quaternium-20 (commercially available as SILPLEX J2-S from Siltech Corporation); mixtures of anionic silicone polymers and fatty amidoamine compounds (commercially available as SILPLEX CS-1 Coco from Siltech Corporation); or any combination thereof.

The tissue softener includes a viscosity modifying agent. The viscosity modifying agent is present in tissue softener in amount in a range between about 5 and about 90 wt. % based on the total weight of the tissue softener. In one aspect, the viscosity modifying agent is present in the tissue softener in amount in a range between about 10 and about 80 wt. % based on the total weight of the tissue softener. In another aspect, the viscosity modifying agent is present in the tissue softener in amount in a range between about 30 and about 70 wt. % based on the total weight of the tissue softener. Still yet, in another aspect, the viscosity modifying agent is present in the tissue softener about or in any range between about 5, 10, 15, 20, 25, 30, 35, 40, 45, 50, 55, 60, 65, 70, 75, 80, 85, and 90 wt. % based on the total weight of the tissue softener.

Non-limiting examples of suitable viscosity modifying agents include emollients, surfactants, silicone compounds, or a combination thereof. Non-limiting examples of suitable emollients include oils, such as mineral oil (C₁₆-C₂₀) and lanolin oil, squalene, polybutene, polyisobutene, polydecene, C₁₃-C₁₄ isoparaffin, C₂₀-C₄₀ isoparaffin: esters, including non-aromatic and aromatic esters, (e.g., ethyl myristate, isopropyl myristate, propylene glycol myristate, isopropyl laurate, methyl palmitate, isocetyl palmitate, ethylhexyl palmitate, isopropyl palmitate, propylene glycol oleate, methyl stearate, n-butyl stearate, ethylhexyl stearate, isopropyl isostearate, propylene glycol isostearate, ethylhexyl pelargonate, ethylhexanoate, decyl cocoate, isoamyl cocoate, decyl oleate, C₁₀-C₃₀ cholesterol/lanosterol ester, caprylic/capric triglyceride, caprylic/capric/lauric triglyceride, di-PPG-3 myristyl ether adipate (commercially available as Cromollient DP3A from Croda, Inc., Edison, N.J.), C₁₂-C₁₅ alkyl benzoate (commercially available as FINSOLV TN from Finetex, Inc., Elmwood Park, N.J.), isostearyl benzoate, phenoxyethyl caprylate, PPG-5 ceteth-20, polyglyceryl-3 caprate, PEG-7 glyceryl cocoate, PEG-80 glyceryl cocoate, PEG-6 caprylic/capric glyceride, PPG-3 benzyl ether 2-ethylhexanoate, PPG-3 benzyl ether myristate); liquid fatty acids (e.g., saturated fatty acids, including C₄-C₁₂ fatty acids such as caproic acid, caprylic acid, and capric acid, and unsaturated fatty acids such as oleic acid and linoleic acid); polyols (e.g., glycol, propylene glycol, 1,2 hexandiol, triethylene glycol, PPG-10 butanediol, and capryl glycol); or any combination thereof.

Non-limiting examples of suitable surfactants for the viscosity modifying agent include non-ionic surfactants, including those with a hydrophilic-lipophilic balance (HLB) value >5, such as sorbitan esters (e.g., sorbitan laurate, polysorbate 20-80 (polysorbate 20 is commercially available as TWEEN 20 from Sigma-Aldrich Corporation, St. Louis, Mo.), polyoxyethylene (20) sorbitan monolaurate, and sorbitan monooleate); polyethoxylated sorbitan esters (e.g., polyoxyethylene (20) sorbitan monopalmitate); secondary alcohol ethoxylates (commercially available as TERGITOL 15 (S3-S9) from Dow Chemical Company, Midland, Mich.); alkyl glucosides; alkyl polyglucosides; or any combination thereof. Non-limiting examples of suitable anionic surfactants include disodium lauryl sulfosuccinate, sodium cocoyl isethionate, sodium lauroyl sarcosinate, sodium methyl cocoyl taurate, sodium monoxynol-6-phospate, or any combination thereof. Non-limiting examples of suitable cationic surfactants include monoalkyl ammonium chloride, dialkyl ammonium chloride, dicetyl dimonium chloride, ethoxylated ammonium chloride, or any combination thereof.

The surfactants used for the viscosity modifying agent can be low hydrophilic-lipophilic balance (HLB) or high HLB surfactants. HLB is a measure of the degree of hydrophobicity/hydrophilicity. HLB can be measured according to the following equation: HLB=20×Mₕ/M, where Mₕ is the molecular mass of the hydrophilic portion of the molecule, and M is the molecular mass of the whole molecule, providing a result on a scale of 0 to 20. An HLB value of 0 corresponds to a substantially lipophilic/hydrophobic molecule, and a value of 20 corresponds to a substantially hydrophilic/lipophobic molecule. Suitable surfactants can have HLB values in a range between about 0 and 10. In another aspect, suitable surfactants can have HLB values in a range between about 10 and about 20. Yet, in another aspect, suitable surfactants can have HLB values about or in any range between about 0, 1, 2, 3, 4, 5, 6, 7, 8, 9, 10, 11, 12, 13, 14, 15, 16, 17, 18, 19, and 20.

Non-limiting examples of suitable silicone compounds for the viscosity modifying agent include non-ionic silicone compounds, e.g., silicone wax, cetyl dimethicone, stearyl dimethicone, behenoxy dimethicone, stearoxy dimethicone, phenyl silicone, phenyl trimethicone, low molecular weight polydimethylsiloxane, high molecular weight polydimethylsiloxane, polyether trisiloxane, amino functional polydimethylsiloxane, amino propyl dimethicone, cyclopentasiloxane, trimethylsiloxy polysilicate, polyether alkyl polymethyl siloxane, cyclomethicone, C₂-C₃₂ alkylated silicones (commercially available as SILWAX DO2 and SILWAX J1016 from Siltech Corporation), aryl siloxane (commercially available as SILWAX DO-MS from Siltech Corporation), alkyl aryl siloxane (commercially available as SILWAX 3H2-MS from Siltech Corporation), silicone multi-ester (commercially available as SILUBE TMP Di-10, SILUBE TMP Di1018 from Siltech Corporation). The viscosity modifying agent can be a cationic silicone compound, e.g., silicone quaternium-22 (commercially available as ABIL T Quat 60 from Evonik Industries), quaternary polydimethylsiloxane (commercially available as SILQUAT J15 and SILQUAT J2-B from Siltech Corporation, Ontario, Canada), silicone fatty amido quats (commercially available as SILQUAT D208-CDA and SILQUAT D208-TDA from Siltech Corporation), silicone polyether fatty quats (commercially available as SILQUAT AD or SILQUAT AC from Siltech Corporation), tertiary amines based on morpholine (commercially available as SILAMINE D10-M from Siltech Corporation), tertiary amines based on ethanolamines (commercially available as SILAMINE D10-D from Siltech Industries), or any combination thereof. Other non-limiting exemplary silicone compounds for the viscosity modifying agent include dimethicone copolyols, such as commercially available SILSURF A008-UP, C208, J208, and D212-CG from Siltech Corporation; silicone dialkyl quats (linear or multiple), such as commercially available SILQUAT AO, D2-B, J208-1B, and J2-B from Siltech Corporation; silicone amines (primary, secondary and tertiary amines, such as commercially available SILAMINE Di-50-D from Siltech Corporation), quaternary polydimethylsiloxane (commercially available as SILQUAT J15 from Siltech Corporation); silicone polyether fatty quats (commercially available as SILQUAT AD from Siltech Corporation); silicone coco monoamide quats (commercially available as SILQUAT D208-CA from Siltech Corporation); silicone coco diamide quats; silicone phosphates, such as commercially available as SILPHOS A-100, J208 from Siltech Corporation, and dimethicone PEG-8-phosphate (commercially available as SILSENSE PE-100 Silicone from Lubrizol Corporation, Wickliffe, Ohio); silicone polyether ester and carboxylates based on fatty acids such as lauric acid and isostearic acid (commercially available as SILWAX WD-IS from Siltech Corporation); polydimethylsiloxane copolyol succinate (commercially available as SILUBE CS-I from Siltech Corporation); complexes of silicone quaternary compound and anionic silicone compounds, such as silicone quaternium-20 (commercially available as SILPLEX J2-S from Siltech Corporation); mixtures of anionic silicone polymers and fatty amidoamine compounds (commercially available as SILPLEX CS-1 Coco from Siltech Corporation); or any combination thereof.

Optionally, the tissue softener includes one or more additives. The additives can provide a variety of benefits for a user. The additives can provide, for example, cleansing benefits, mild cooling benefits, soothing benefits, anti-itch benefits, pain relief benefits, deodorizing benefits, warming benefits, and/or anti-irritant benefits.

When present, the additive(s) can be present in the tissue softener in an amount in a range between about 0.1 and about 85 wt. % based on the total weight of the tissue softener. In another aspect, the additive(s) are present in an amount about or in any range between about 1, 5, 10, 15, 20, 25, 30, 35, 40, 45, 50, 55, 60, 65, 70, 75, 80, and 85 wt. % based on the total weight of the tissue softener. The additive(s) can be included to provide skin care benefits (a skin care additive) or antimicrobial properties to the tissue (antimicrobial additive).

Non-limiting examples of suitable additives include soothing/healing additives, such as allantoin, aloe vera (for example, commercially available PHYTOCONCENTROLE from Symrise AG, Holzminden, Germany), vitamin E, ben oil (moringa oil), mink oil, witch hazel extract, willow extract, green tea extract, chamomile extract, jasmine extract, mixtures of butylene glycol, pentylene glycol, and hydroxyphenyl propamidobenzoic acid, and mixtures of bisabolol and hydroxymethoxyphenyl decanone (for example, commercially available SYMRELIEF S from Symrise AG); cooling additives, such as menthol glycerine acetal, menthyl lactate (for example, commercially available FRESCOLAT ML from Symrise AG), menthol, and the like; warming additives, such as ginger root extract, peppermint extract, eucalyptol, vanillyl butyl ether (for example, commercially available HOTACT VBE from Vantage Specialty Ingredients, Inc., Warren, N.J.), and the like; antimicrobial synthetic and natural compounds, such as ammonium iodide, benzyl alcohol, chlorhexidine gluconate, chlohexidine diacetate, benzalkonium chloride, benzethonium chloride, lanosol, caprylic acid, nonanoic acid, tea tree oil, citron oil, eucalyptus extract, rosemary extract, sandalwood extract, and the like; skin pH balancing additives, such as alpha and beta hydroxy acids (e.g., glycolic acid, lactic acid, malic acid, and the like), caprylic acid, gallic acid, and the like; deodorant/deoderizing additives, such as farnesol, zinc ricinoleate, chlorophyllin-copper complex, abietic acid, triethyl citrate, soyethyl morpholinium ethosulfate (for example, commercially available COLA QUAT SME from Colonial Chemical, Inc., South Pittsburgh, TN); pain relief additives, such as lidocaine, benzocaine, tetracaine, capsaicin, ketoprofen, diclofenac, ibuprofen, ketamine, dibucaine, butamben picrate, pramoxine, and combinations thereof; cleansing agents or surfactants, including non-ionic surfactants, such as PEG-20 methyl glucose sesquistearate (for example, commercially available glucamate SSE20 from Lubrizol Corp., Wickliffe, Ohio), sorbitan esters (e.g., sorbitan laurate, polysorbate 20-80 (polysorbate 20 is commercially available as TWEEN 20 from Sigma-Aldrich Corporation, St. Louis, Mo.), polyoxyethylene (20) sorbitan monolaurate, and sorbitan monooleate), polyethoxylated sorbitan esters (e.g., polyoxyethylene (20) sorbitan monopalmitate), secondary alcohol ethoxylates (commercially available as TERGITOL 15 (S3-S9) from Dow Chemical Company, Midland, Mich.), alkyl glucosides, alkyl polyglucoside, and sodium bis-hydroxyethylglycinate lauryl-glucosides crosspolymer (for example, POLY SUGA GLYCINATE L from Colonial Chemical, Inc.); oils, such as coconut oil, theobroma oil (cocoa butter), olive oil, corn oil, carnation oil, soy bean oil, tubaki oil, cottonseed oil, sesame oil, avocado oil, jojoba oil, safflower oil, apricot oil, evening primrose oil, rose hip oil, grapeseed oil, carrot seed oil, eucalyptus oil, chamomile oil, neroli oil, tea tree oil, ylang ylang oil, spearmint oil, lavender oil, peppermint oil, sandalwood oil, squalane, mink oil, turtle oil, emu oil, cod liver oil, orange roughy oil, mink oil, polybutene, isopropyl myristate, isocetyl myristate, cetylisooctansate, isostearic acid, caproic acid, caprylic acid, capric acid, lauric acid, myristic acid, palmitic acid, palmitoleic acid, stearic acid, oleic acid, stearic acid, linoleic acid, linolenic acid, polyethylene glycol, polyethylene glycol 400, polyethylene glycol 860 monooleate, propylene glycol, glycerol, methylene glycol, polypropylene glycol, Guerbet ester, isostearyl alcohol, oleyl alcohol, cetyl alcohol, cetostearyl alcohol, stearyl alcohol, octamethylcyclotetrasiloxane, mineral oil, spindle oil, and tamanu oil; or any combination thereof.

A fragrance can also be incorporated into the tissue softener as an additive. A fragrance can also be applied to the core of the tissue product itself. Non-limiting examples of fragrances includes volatile aromatic esters, non-aromatic esters, aromatic aldehydes, nonaromatic aldehydes, aromatic alcohols, non-aromatic alcohols, heterocyclic aroma chemicals, natural floral fragrances, such as blossom, carnation, gardenia, geranium, iris, hawthorne, hyacinth, lavender, and jasmine, or any combinations thereof.

When tissues are dried on a Yankee dryer, a creping adhesive can be used to adhere the web to the surface of the Yankee dryer drum. When tissue softeners are diluted with water before depositing onto a cellulosic substrate, water associated with a dilute softener or water emulsion can interfere with substrate adhesion to the Yankee by solubilizing and washing away the creping adhesive. Spray application of diluted softener chemistry often leads to clogged nozzles, which leads to non-uniformity in application. Even small variations or non-uniformities in application of diluted softeners leads to adhesion issues at the Yankee dryer, thus causing productivity and product quality issues. However, adding a viscosity modifying agent as disclosed herein to the tissue softener changes the viscosity and allows for spraying an undiluted, substantially waterless softener onto a substrate without nozzle clogging issues. Thus, the tissue softeners disclosed herein do not substantially interfere with tissue adhesion to a Yankee dryer during manufacture, which can be a problem faced with water-diluted chemical softeners.

Tissues include the above disclosed tissue softeners disposed onto one or more surfaces. The tissue softener can be sprayed, printed, roll coated, or deposited by any other methods known in the art onto the tissue. Such inventive softener compositions also reduce the overall water volume in the tissue making process, avoiding Yankee coating issues.

Water has a viscosity of about 1 to 10 cP, and other commercially available softeners when applied in diluted form can have similar viscosities. The viscosity of commercially available Softener PA-A and B 100 is 1050 cP and 800 cP, respectively. Current practice involves spraying diluted 2.5-5.0% solids softener to provide a viscosity of about 1-20 cP after dilution. For example, commercially available Softener PA-A (a mixture of sorbitan oleates, ethoxylated alkyl amines, monoesters of the ethoxylated amines, and free PEG) has a viscosity of 6-20 cP after dilution. Commercially available VARISOFT GP B 100 from Evonik Industries (primarily a mixture of imidazolium compounds, 2-(C17 and C17 unsaturated alkyl)-1-[2-(C18 and C18 unstaturated amido)ethyl]-4,5-dihydro-1-methyl, methylated sulfates and 1,2-propanediol) has a viscosity of about 6-20 cP after dilution.

Viscosity disclosed herein is measured using a Brookfield DV-E viscometer (commercially available from Brookfield Engineering Laboratories Inc., Middleboro, Mass.). A 250 milliliter (ml) sample is deposited into a 300 ml beaker or any other container sufficiently large to avoid wall effects. The sample temperature is maintained substantially constant at 23±0.2° Celsius (° C.) by placing the beaker with sample into a 23° C. water bath (room temperature) and allowing it to equilibrate. Initially, the viscometer is leveled. When the motor is off, the appropriate spindle is attached to the viscometer (#3 can be used). The spindle is attached to the coupling nut by slightly lifting the shaft and holding it firmly with one hand while screwing the spindle on with the other hand, while not putting the side thrust on the shaft. The spindle is immersed into the sample so that its annular groove is at the surface level of the sample. The spindle should be in the center of the sample container opening. Air bubbles should not be trapped under the spindle disk. The center spindle is inserted into the sample material until the fluid's level is at the immersion groove on the spindle's shaft. The motor is switched on and set to a speed of 60 rpm. The reading is allowed to stabilize and then recorded.

The tissue softener disclosed herein has a viscosity of at least 100 cP. In one aspect, the tissue softener has a viscosity in a range between about 100 and 4000 cP. In another aspect, the tissue softener has a viscosity in a range between about 400 and 900 cP. Yet in another aspect the tissue softener has a viscosity in a range between about 500 and 1100 cP. Still in another aspect, the tissue softener has a viscosity about or in any range between about 100, 150, 200, 250, 300, 350, 400, 450, 500, 550, 600, 650, 700, 750, 800, 850, 900, 950, 1000, 1500, 2000, 2500, 3000, 3500, and 4000 cP.

Reduced overall water content in the tissue softener results in a reduced drying load, or energy required to dry the tissue, measured in terms of Yankee hood temperature. Thus, the tissue softener increases production capacity because machine speed can be increased. In one example, the average Yankee hood temperature used to dry a tissue without any softener (water only) is about 540° F., and the average temperature to dry a tissue prepared with water diluted softener is between 550 and 570° F. However, the average Yankee hood temperature used to dry a tissue prepared with the tissue softener disclosed herein is substantially lower and between about 475° F. and about 530° F. Although the Yankee hood temperature depends on many variables (e.g., machine speed, sheet solids, basis weight), the average Yankee hood temperature utilized for making tissues with the inventive softeners is at least 50° F. lower than with a like diluted spray softener.

The tissue softener improves tissue SS compared to diluted softeners and water alone. When disposed onto a tissue, the tissue softener provides a tissue with a SS of at least 18.7. For comparison, water alone provides a tissue with a lower SS of about 18.4. In one aspect, the tissue softener provides the tissue with at least a 0.3 unit increase compared to a like diluted tissue softener.

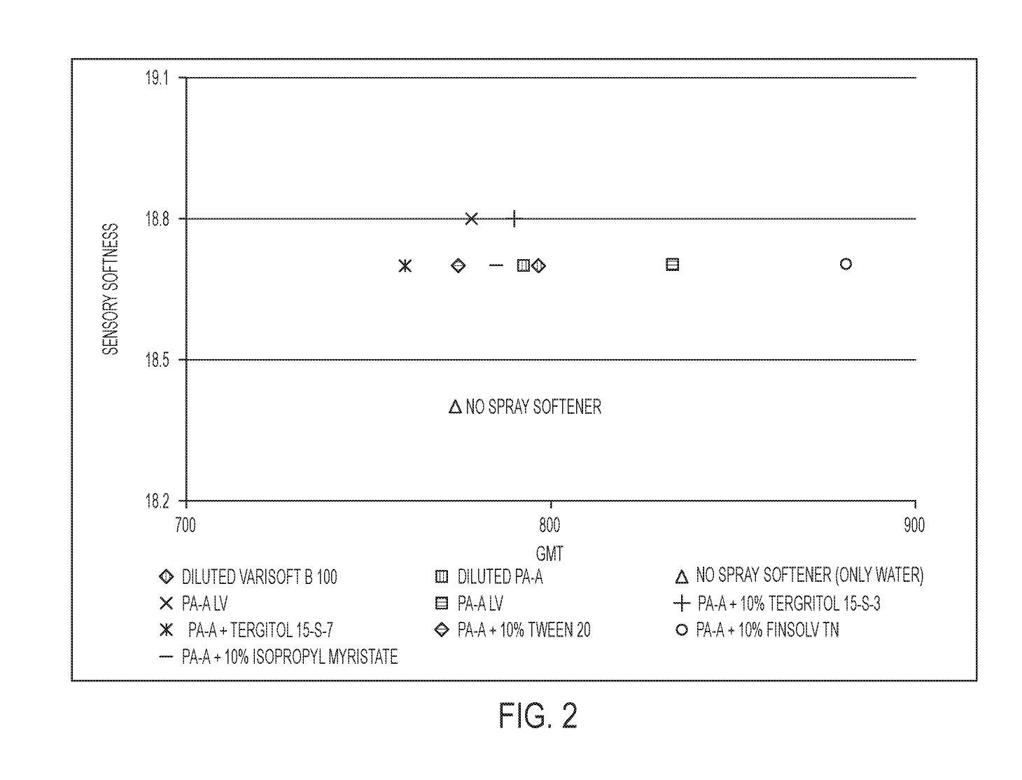

Although the tissue softener improves a tissue's SS, the tissue's tensile strength loss compared to a water-diluted softener application is simultaneously reduced. The geometric mean tensile (GMT) of tissues prepared with the tissue softener is substantially unchanged or only marginally affected after the inventive undiluted tissue softener is applied. This property reduces the chemical usage and/or refining energy used to make a similar tissue product. FIG. 2 (discussed below in Example 3) is a graph of tissue Sensory Softness as a function of GMT.

In some aspects, a tissue having the tissue softener disposed on a surface has a GMT in a range from about 500 to about 1500 g/3 in. In other aspects, a tissue having the tissue softener disposed on a surface has a GMT in a range from about 700 to about 1200 g/3 in. Yet, in other aspects, a tissue having a tissue softener disposed on a surface has a GMT about or in any range from about 500, 550, 600, 650, 700, 750, 800, 850, 900, 950, 1000, 1050, 1100, 1150, and 1200 g/3 in.

Still yet, in some aspects, a towel having the tissue softener disposed on a surface has a GMT in a range from about 1500 to about 3000 g/3 in. In other aspects, a towel having the tissue softener disposed on a surface has a GMT in a range from about 1700 to about 2700 g/3 in. Yet, in other aspects, a towel having a tissue softener disposed on a surface has a GMT about or in any range from about 1500, 1600, 1700, 1800, 1900, 2000, 2100, 2200, 2300, 2400, 2500, 2600, 2700, 2800, 2900, and 3000 g/3 in.

Compared to water diluted softeners, the tissue softener also provides higher % retention on the tissue. For example, the tissue softener is retained on the tissue (% retention) in an amount of at least 40% based on the total volume of softener applied to the substrate. In contrast, when the tissue softener is diluted with water, the diluted softener is retained with a % retention of less than 50/o based on the total volume of tissue softener deposited. In one aspect, the tissue softener is retained with a % retention in a range between about 40 and about 85° % based on the total volume deposited on the surface. In another aspect, the tissue softener is retained with a % retention about or in any range between about 50, 55, 60, 65, 70, 75, 80, 85, 90, 95, and 100% based on the total volume deposited on the surface.

The tissue includes cellulosic fibers and is a cellulosic substrate. The cellulosic substrate can be formed according to any methods known to those skilled in the art. Methods of making the cellulosic substrate include conventional wet pressing (CWP), through air drying (TAD), structured web making processes, eTAD, Yankee/air-drying, ATMOS, NTT, UCTAD, hybrids and variations thereof. The substrate can be creped or uncreped.

The tissue can include any fibers incorporating cellulose as a constituent. In one aspect, the cellulosic fibers are secondary, recycled fibers. In another aspect, the cellulosic fibers are derived from hardwood fibers, such as hardwood kraft fibers, hardwood sulfite fibers; softwood fibers, such as softwood kraft fibers, softwood sulfite fibers, or any combination thereof.

Optionally, the tissue can include a wet strength agent. The wet strength agent can be incorporated into fiber slurry with cellulosic fibers and can be present in a range between about 0.05% to about 1.50% by weight of the total weight of the cellulosic substrate. The wet strength agent includes temporary, as well as permanent, wet strength agents. Non-limiting examples of suitable wet strength agents include glyoxal; glutaraldehyde; uncharged chemical moieties, such as dialdehydes, aldehyde-containing polyols, uncharged aldehyde-containing polymers, and cyclic ureas and mixtures thereof, and aldehyde-containing cationic starch; mixtures of polyvinyl alcohol and salts of multivalent anions, such as boric acid or zirconium ammonium carbonates; glyoxalated polyacrylamide; polyamide-epichlorohydrin; polyamine-epichlorohydrin; ureaformaldehyde; melamine-formaldehyde; polyethyleneimine; or any combinations thereof.

Tissues can be prepared by any methods known in the art and the described methods are not intended to be limiting. CWP tissues can be prepared by mixing the cellulosic fibers with water and any desired additives to produce a fiber slurry with a consistency of about 1% to about 5%. The fiber slurry is diluted to a consistency of about 0.1% to about 1.0% and transferred through a centrifugal pump to a headbox. From the headbox, the fibrous mixture is deposited onto a moving fabric, foraminous surface, or wire, to form the cellulosic substrate, or a nascent web. Water can drain through the fabric or wire by applying a vacuum and/or drainage elements. For drying, a creping adhesive can be sprayed onto the surface of a Yankee dryer drum. The nascent web can be transferred onto the hot Yankee dryer via one or two press rolls. The web is dried on the Yankee dryer and then removed with a creping doctor, which scrapes the web from the surface of the Yankee dryer drum. Then, the dried web is wound into a roll at the reel of the paper machine. The described CWP tissue methods are but one example, and other methods known in the art for making tissues can be used with the substantially waterless softener compositions.

The tissue softener can be applied or deposited onto the cellulosic substrate by any suitable method. The tissue softener can be applied to one side or both sides of the cellulosic substrate. The tissue softener composition can be applied to a wet substrate or dry substrate. In one aspect, the tissue softener is applied to a dry substrate, for example after drying on a Yankee dryer. In another aspect, the tissue softener is applied to the wet substrate and then dried on a Yankee dryer.

The tissue softener can be initially deposited onto a surface (other than a tissue substrate) and then deposited onto the tissue surface by transferring a substrate comprising cellulosic fibers onto the tissue softener on the surface. The surface can be, for example, a roll, a fabric, a belt, or other like surfaces.

In one aspect, the tissue softener is applied to the dry cellulosic substrate during the conversion process. When applied to a dry sheet, for example, after the Yankee dryer, the tissue softener can include skin care additives to provide benefits to a user. During conversion, a paper sheet from a jumbo reel is converted to a tissue paper, which can include embossing. Several plies can be assembled together to form a multi-ply sheet. The tissue softener can be applied to a single ply on one side or both sides. Following optional embossing or multi-ply assembly, the converted sheet is guided to a station for winding and cutting to form individual rolls. The tissue softener can be applied to the cellulosic substrate after the Yankee dryer step, but before the conversion process. In one aspect, the tissue softener is applied to the cellulosic substrate during or between any steps of the conversion process, e.g., before or after embossing, multi-ply assembly, winding, or cutting.

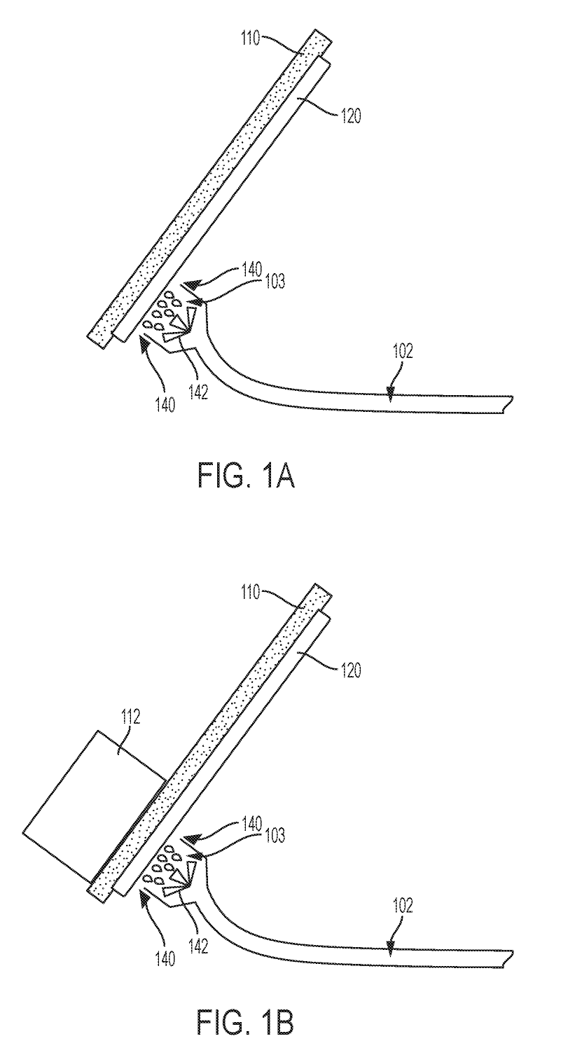

FIGS. 1A and 1B illustrate a method of depositing the tissue softener 102 onto the surface of the cellulosic substrate 120. The cellulosic substrate 120 is creped onto the creping fabric 110. A softening agent is combined or mixed with a viscosity modifying agent to provide the tissue softener 102, which is sprayed using the air atomizing nozzles 142. Softener chemistry along with compressed air is fed into the air atomizing nozzles 142. The atomized liquid 103 is sprayed onto the surface of the cellulosic substrate 120. Air knives 140 before and after the air atomizing nozzles may or may not be used to break the air boundary. A containment box is used to physically limit the spreading of atomized liquid 103. The containment box may have some vacuum, or optionally, a vacuum box 112 could be used as shown in FIG. 1B. Optionally, vacuum can be used to control air flow in the treated substrate.

The tissue softener can also be deposited onto the tissue surface by any spraying method, including but not limited to air atomized spraying methods (e.g. commercially available from Spraying System Co.), ultrasonic spraying methods (e.g., spray atomization technology commercially available from Aurizon Ultrasonics, LLC, Kimberly, Wis.) and vector metered spray applicators (e.g., VECTOR spray adapter commercially available from ITW Dynatec, Hendersonville, Tenn.).

When applied to a web tissue substrate (e.g., before drying on a Yankee dryer), the tissue softener can form a gel or emulsion on contact with the wet surface. In one aspect, the tissue softener forms liquid crystal gels on contact with water on the surface of a wet substrate.

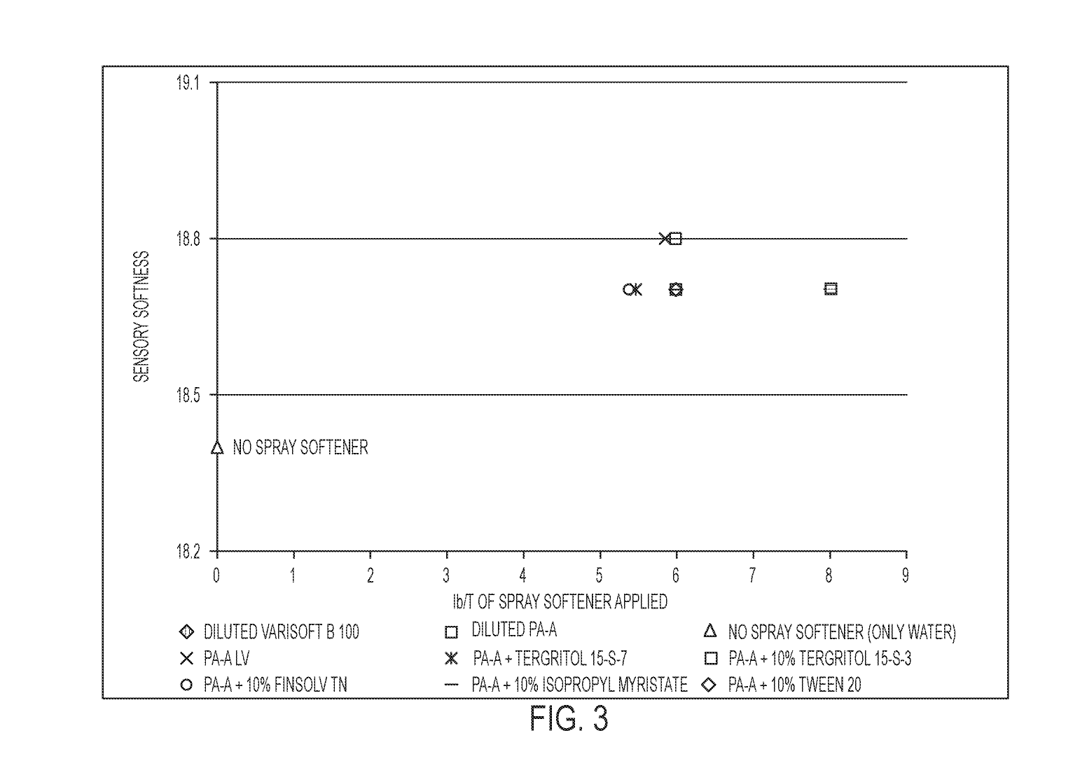

The tissue softener can be applied to the cellulosic substrate in an amount in a range between from about 0.025% to about 20% by weight of tissue. For example the tissue softener can be applied to the cellulosic substrate in an amount of about or in any range between about 1, 3, 5, 7, 10, 12, 15, 18, and 20% by weight of the tissue. However, the tissue softener can be applied to the cellulosic substrate in any amount desired to achieve the target softness or product. FIG. 3 (discussed below in Example 4) is a graph of normalized SS as a function tissue softener applied to a tissue.

### EXAMPLES

### Example 1

Various viscosity modifying agents were mixed with Softener PA-A (a mixture of sorbitan oleates and ethoxylated alkyl amines) to evaluate the impact on uniformity of coverage, % retention, and sensory softness (SS). Viscosity modifying agents with a range of hydrophobicities (TERGITOL 15-S-3, TERGITOL 15-S-7, FINSOLV TN, and TWEEN 20) were compared, as well as aliphatic viscosity modifying agents such as isopropyl myristate. For a control comparison, the softener compositions were diluted to 2.5-5% with water. The HLB was used as a measure of the viscosity modifying agent's degree of hydrophobicity/hydrophilicity. Waterless softener application trials were conducted on a structured web making paper machine.

The following Softener PA-A Softener and viscosity modifying agent combinations were evaluated:
1. PA-A LV (“Low viscosity PA-A” with 3% glycol-type diluent)
2. PA-A+10% TERGITOL 15-S-3 (TERGITOL 15-S-3 is a secondary alcohol ethoxylate hydrophobic wetting agent, HLB=8)
3. PA-A+10% TERGITOL 15-S-7 (TERGITOL 15-S-7 is a secondary alcohol ethoxylate hydrophilic wetting agent, HLB=12.1)
4. PA-A+10% TWEEN 20 (TWEEN 20 is a hydrophilic wetting agent, HLB=16.7)
5. PA-A+10% FINSOLV TN (FINSOLV TN is an aromatic emollient ester, hand-feel enhancer)
6. PA-A+10% isopropyl myristate (isopropyl myristate is a linear emollient ester, hand-feel enhancer)

Table 1 shows the experimental parameters for tissues produced using the above softener compositions. Tissues prepared without softener were compared as a control (cell 1). In control cell 1, water was mixed with tracer chemistry and sprayed onto the substrates using a traditional spray boom. Table 2 shows the machine process conditions. Table 3 shows the converting specifications.

TABLE 1
Trial cell description

| | | | % Solids of |
|---|---|---|---|
| Cell | Spray | Viscosity | Spray Softener |
| No. | Softener | [cP] | at Application |
| 1 | None | 1-10 | 0% (Spray water only) |
| 2 | PA-A | 6-20 | 5% (Usual control) |
| 3 | VARISOFT GP | 6-20 | 5% (Usual control |
| | B 100 | | |
| 4 | PA-A LV | 620 | 100% (Spray Neat) |
| 5 | PA-A + 10% | 515 | 100% (Spray Neat) |
| | TERGITOL 15-S-3 | | |
| 6 | PA-A + 10% | 580 | 100% (Spray Neat) |
| | TERGITOL 15-S-7 | | |
| 7 | PA-A + 10% | 430 | 100% (Spray Neat) |
| | TWEEN 20 | | |
| 8 | PA-A + 10% | 575 | 100% (Spray Neat) |
| | Finsolv TN | | |
| 9 | PA-A + 10% | 430 | 100% (Spray Neat) |
| | Isopropyl Myristate | | |

TABLE 2
Machine process conditions

| Process Variable | Location | Rate |
|---|---|---|
| Furnish - | 100% HW Kraft to Yankee layer | Stratified |
| 65% HW Kraft, | 70% SW Kraft & 30% HW Kraft | |
| 35% SW | to M&A | |
| Kraft | | |
| Machine Speed | Yankee | 1835 fpm |
| Refiner | Only SW | Vary as needed |
| Temporary | Evenly split in the two layers | 3 lb/T |
| Wet Strength - | | |
| FJ 98 | | |
| Starch - | Evenly split in the two layers | 8 lb/T |
| RediBOND 5330A | | |
| Softener | Spray on the wet web on the | Dependent |
| | creping medium | on cell |
| Fabric Crepe | Crepe Roll | 20% |
| Reel Crepe | Reel | 7% |
| Molding Box | Molding box | Maximum |
| Vacuum | | |

### Example 2

TABLE 3
Converting specifications

| Specs/Winder | Parameter |
|---|---|
| Conversion Process | Gluing |
| No. of Plies | 2 |
| Emboss Pattern | U19 (300-00436) |

Using the above parameters, the finished tissues were tested for sensory softness (SS) and physical properties

As shown in Table 4, the undiluted (substantially water-free) Softener PA-A combined with the emollient provided about a 0.3 higher sensory softness compared to water alone (no softener). All of the viscosity-modified PA-A's provided similar or better softness than diluted application of the VARISOFT GP B 100 softener (a mixture of imidazolium compounds) and PA-A.

No significant impact on the Yankee drying process was observed. In particular, no coarse crepe, banding, uneven buildup of coating, picking, etc. occurred. The same coating settings were used for the diluted and undiluted softeners.

TABLE 4
Comparison of finished products

| | VARISOFT | | | | | PA-A + 10% | | | | |
|---|---|---|---|---|---|---|---|---|---|---|
| | GP B | | | PA-A | PA-A | TERGITOL 15- | TERGITOL 15- | TWEEN | Finsolv | Isopropyl |
| Chemistry | 100 | PA-A | Water | LV | LV | S-3 | S-7 | 20 | TN | myristate |
| Application | Diluted | Diluted | Diluted | Undiluted | | | | | | |
| Type | | | | | | | | | | |
| Chemistry | 6 | 6 | — | 5.86 | 8.02 | 6 | 5.47 | 7.98 | 5.38 | 6 |
| Applied | | | | | | | | | | |
| [lb/T] | | | | | | | | | | |
| Analytical | 56% | 49% | — | 95% | 90% | 81% | 86% | 75% | 78% | 83% |
| (% | | | | | | | | | | |
| Retention) | | | | | | | | | | |
| Sensory | 18.7 | 18.7 | 18.4 | 18.8 | 18.7 | 18.8 | 18.7 | 18.7 | 18.7 | 18.7 |
| Softness | | | | | | | | | | |
| GMT | 797 | 852 | 774 | 778 | 833 | 790 | 760 | 775 | 881 | 785 |

### Example 3

FIG. 2 shows the tissue sensory softness as a function of geometric mean tentile (GMT) for the various cells. All the cells made using either diluted or undiluted (substantially water-free) spray softener resulted in sensory softness of 18.7 or 18.8. Tissues without any softeners had a sensory softness of 18.4 (see also Table 4). These results demonstrated the advantage of substantially water-free (undiluted) softeners, which also provide comparable sensory softness to diluted softeners (˜0.3 higher).

### Example 4

FIG. 3 shows sensory softness plotted against the application rate for the various chemistries in Example 1. All the substantially water-free PA-A versions that included viscosity modifiers provided similar or better softness than diluted application of VARISOFT GP B 100 and PA-A softeners.

### Example 5

Table 5 shows the % chemical retention (% retention) on the substrates for the various cells (also shown in Table 4). The chemical retention of the diluted spray softener was about 45-55% by weight of the amount initially deposited. However, surprisingly, the retention of the undiluted spray softeners was higher, about 75-95%.

TABLE 5
Percent retention of various spray softeners (diluted/undiluted)

| | Application | Application | |
|---|---|---|---|
| | Type [Diluted/ | Rate | % |
| Chemistry | Undiluted] | [lb/T] | Retention |
| GP-B 100 | Diluted | 6.0 | 56% |
| PA-A | | 6.0 | 49% |
| PA-A LV | Undiluted | 5.9 | 95% |
| PA-A LV | | 8.0 | 90% |
| PA-A + 10% TERGITOL | | 6.0 | 81% |
| 15-S-3 | | | |
| PA-A + TERGITOL 15-S-7 | | 5.5 | 86% |
| PA-A + 10% TWEEN 20 | | 8.0 | 75% |
| PA-A + 10% Finsolv TN | | 5.4 | 78% |
| PA-A + 10% isopropyl | | 6.0 | 83% |
| myristate | | | |

### Example 6

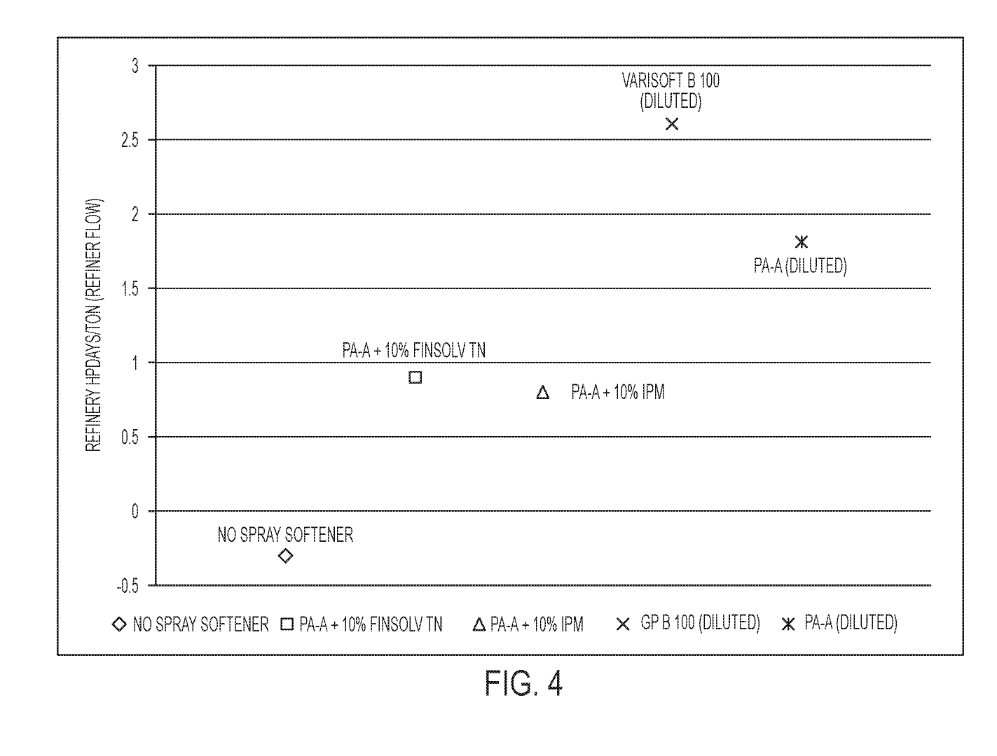

Table 6 compares the key process conditions of each cell. Undiluted substantially waterless spray softener leads to an approximately 50° F. reduction in Yankee hood temperature and surprisingly about 1 HPDays/Ton (refiner flow) reduction in the refining. Reduced refining energy reduces the energy cost. The undiluted softeners provide reduced refiner flow compared to the diluted softeners (see also FIG. 4, which illustrates the data shown in Table 6).

TABLE 6
Comparison of key process conditions

| | | | | | Average |
|---|---|---|---|---|---|
| | | | | | Yankee |
| | | | | Refining | Hood |
| Cell | | | Starch | Energy | Temp. |
| No. | Description | | [lb/T] | (HPDays/T) | (° F.) |
| 1 | GP B 100 | | 8.1 | 2.6 | 569 |
| | (Diluted); 6 lb/T | | | | |
| 2 | PA-A (Diluted); | | 8.1 | 1.8 | 553 |
| | 6 lb/T | | | | |
| 3 | No Spray Softener | | 6.1 | −0.3 | 541 |
| | (Only Water) | | | | |
| 4 | PA-A LV; 5.86 | | 8.1 | 1.1 | 519 |
| | lb/T | | | | |
| 5 | PA-A + | TERGITOL | 8.1 | 0.9 | 490 |
| | 10% | 15-S-7; | | | |
| | | 5.47 lb/T | | | |
| 6 | | TERGITOL | 8.1 | 1.4 | 527 |
| | | 15-S-3; | | | |
| | | 6 lb/T | | | |
| 7 | | Finsolv TN; | 8.1 | 0.9 | 490 |
| | | 5.38 lb/T | | | |
| 8 | | isopropyl | 8.1 | 0.8 | 494 |
| | | myristate; | | | |
| | | 6 lb/T | | | |
| 9 | | TWEEN 20; | 8.1 | 0.6 | 498 |
| | | 7.97 lb/T | | | |

| | | | | |
|---|---|---|---|---|
| 10 | PA-A LV; 8.02 | 8.1 | 0.8 | 475 |
| | lb/T | | | |

### Example 7

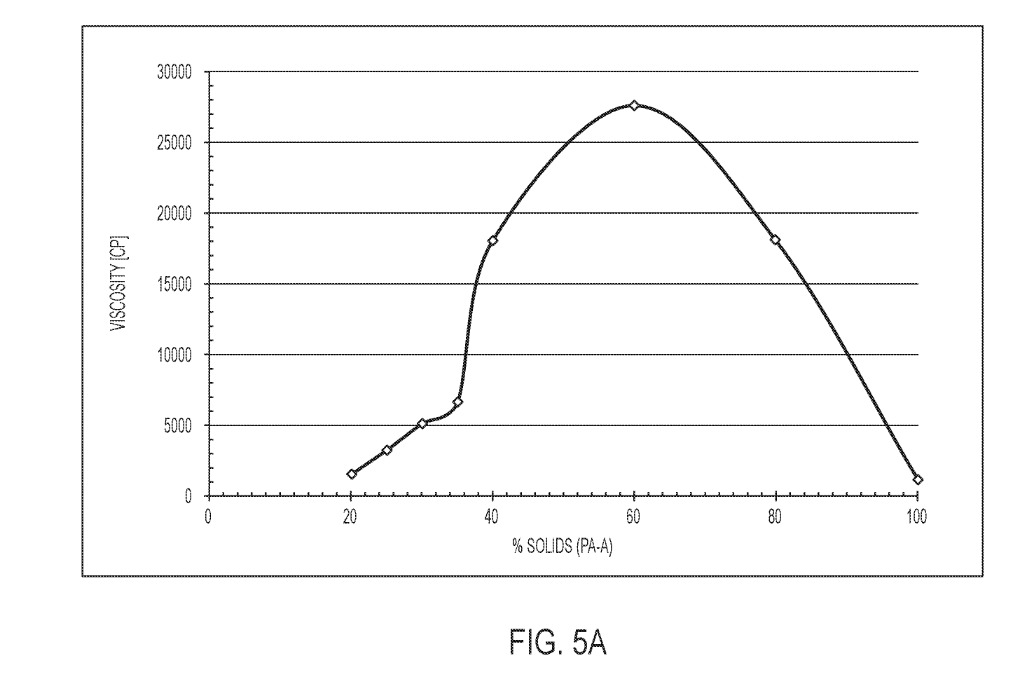

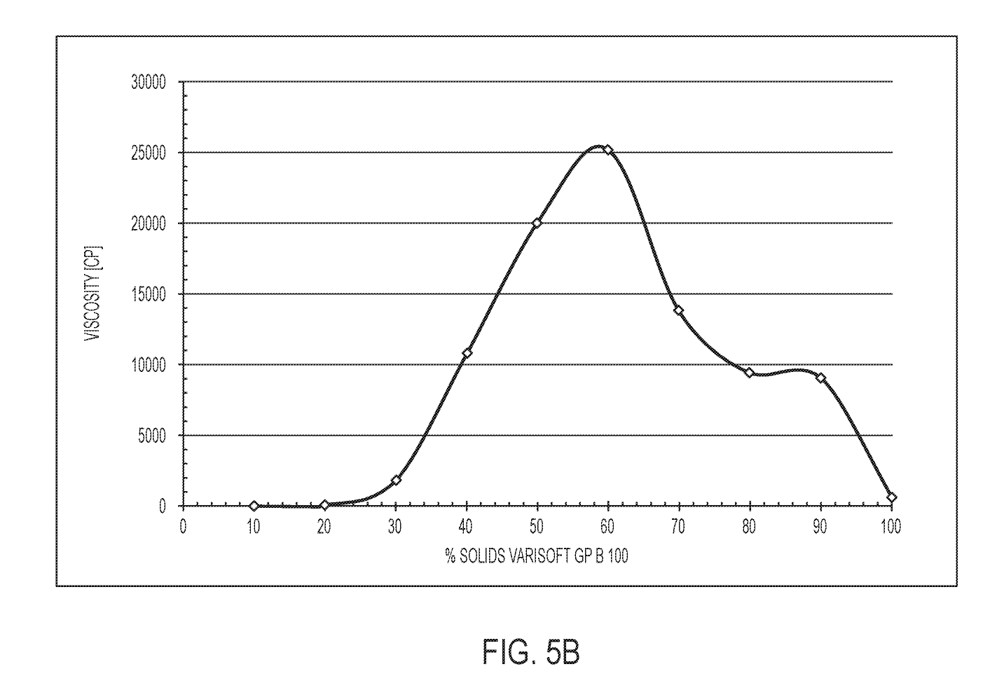

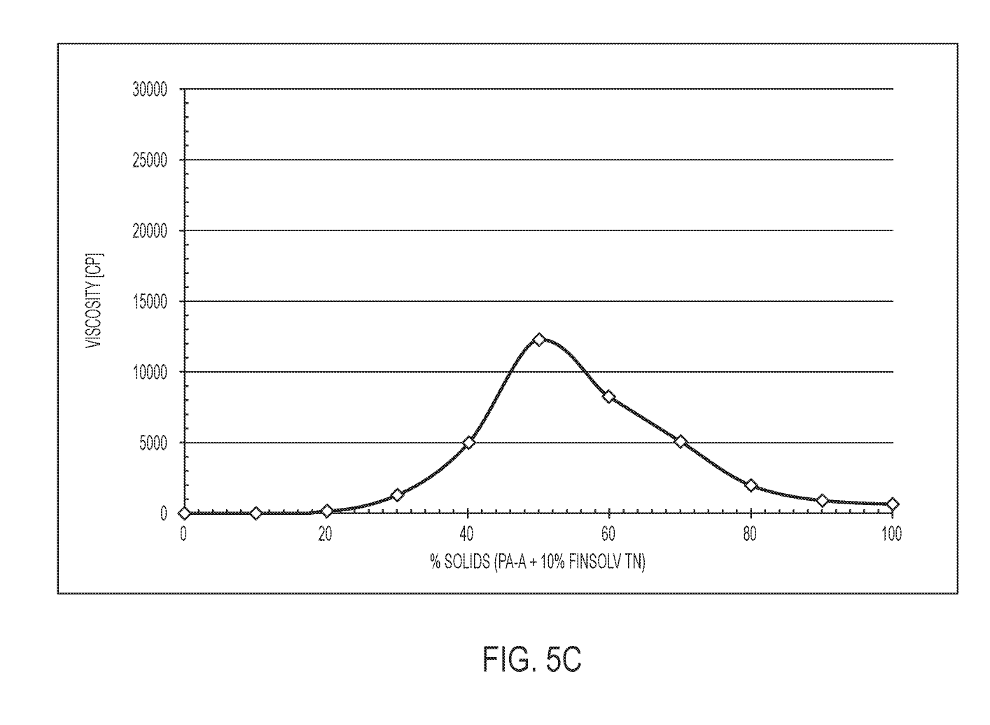

FIGS. 5A-5C show graphs of viscosity as a function of % solids in various tissue softener compositions. FIG. 5A shows the impact of water dilution on the viscosity of Softener PA-A. FIG. 5B shows the impact of water dilution on the viscosity of VARISOFT GP B 100 softener. FIG. 5C shows the impact of water dilution on the viscosity of Softener PA-A+10 wt. % Finsolv TN (a viscosity modifying agent). As shown in FIGS. 5A-5C, viscosity increases as waterless chemistries are diluted with water. Without being bound by theory, it is hypothesized that as the chemistry (softening agents and viscosity modifying agents) contacts the water in the wet tissue sheet, the viscosity increases. The increased viscosity prevents migration of the tissue softener composition into the tissue. Maintaining the tissue softener chemistry on the surface leads to higher softness and lower strength loss.

### Example 8

Table 7 shows properties of tissues having tissue softeners disposed thereon post-Yankee. Table 8 shows properties of towels having tissue softeners disposed thereon. As shown, the tensile of tissues and towels are not substantially affected by the tissue softeners.

TABLE 7
Properties of tissues containing softeners added post-Yankee (on converting)

| | | | | | | | | | Wet |
|---|---|---|---|---|---|---|---|---|---|
| | | | | | | | | | Tensile |
| | Application | | Caliper | Tensile | Tensile | Tensile | Stretch | Stretch | Finch |
| | Rate | Basis Weight | 8 Sheet | MD | CD | GMT | MD | CD | CD |
| Description | [% w/w] | [lb/3000 ft²] | [mils/8 sht] | [g/3 in] | [g/3 in] | [g/3 in] | [%] | [%] | [g/3 in] |
| PA-A + 10% | 0 | 27.3 | 131 | 1,295 | 748 | 984 | 25 | 8.8 | 74.9 |
| Finsolv TN | | | | | | | | | |
| PA-A + 10% | 0.5 | 27.5 | 134 | 1,252 | 706 | 940 | 25 | 9.0 | 75.9 |
| Finsolv TN | | | | | | | | | |
| PA-A + 10% | 2 | 27.4 | 135 | 1,184 | 657 | 882 | 25 | 9.4 | 71.4 |
| Finsolv TN | | | | | | | | | |
| PA-A + 10% | 8 | 28.4 | 134 | 1,089 | 624 | 824 | 24 | 8.6 | 72.3 |
| Finsolv TN | | | | | | | | | |

TABLE 8
Properties of towels containing softeners added post-Yankee (on converting)

| | | | | | | | | | Wet |
|---|---|---|---|---|---|---|---|---|---|
| | | | | | | | | | Tensile |
| | Application | | Caliper | Tensile | Tensile | Tensile | Stretch | Stretch | Finch |
| | Rate | Basis Weight | 8 Sheet | MD | CD | GMT | MD | CD | CD |
| Description | [% w/w] | [lb/3000 ft²] | [mils/8 sht] | [g/3 in] | [g/3 in] | [g/3 in ] | [%] | [%] | [g/3 in] |
| PA-A + 10% | 0 | 24.38 | 164.3 | 3,221 | 1,273 | 2024 | 62.2 | 24.1 | 357 |
| Finsolv TN | | | | | | | | | |
| PA-A + 10% | 0.5 | 24.36 | 162.4 | 3,144 | 1,896 | 1896 | 61.5 | 22.2 | 370 |
| Finsolv TN | | | | | | | | | |
| PA-A + 10% | 2 | 24.60 | 162.4 | 3,132 | 1,917 | 1917 | 62.2 | 19.4 | 399 |
| Finsolv TN | | | | | | | | | |
| PA-A + 10% | 5 | 24.56 | 166.8 | 2,708 | 1,636 | 1636 | 61.6 | 20.1 | 340 |
| Finsolv IN | | | | | | | | | |
| PA-A + 10% | 8 | 23.93 | 143.1 | 2,871 | 1,662 | 1662 | 58.2 | 19.3 | 356 |
| Finsolv TN | | | | | | | | | |
| PA-A + 10% | 5 | 32.86 | 255.5 | 4,779 | 2,774 | 2774 | 44.5 | 22.5 | 486 |
| Finsolv TN | | | | | | | | | |
| PA-A + 10% | 8 | 32.67 | 248.3 | 4,475 | 2,603 | 2603 | 43.6 | 21.3 | 470 |
| Finsolv TN | | | | | | | | | |

With respect to the above description, it is to be realized that the optimum proportional relationships for the parts of the invention, to include variations in components, concentration, shape, form, function, and manner of manufacture and use, are deemed readily apparent and obvious to one skilled in the art, and all equivalent relationships to those illustrated in the specification are intended to be encompassed by the present invention.

Therefore, the foregoing is considered as illustrative only of the principles of the invention. Further, various modifications may be made of the invention without departing from the scope thereof, and it is desired, therefore, that only such limitations shall be placed thereon as are imposed by the prior art and which are set forth in the appended claims.

What is claimed is:

1. A tissue softener comprising a softening agent and a viscosity modifying agent, having a viscosity of at least 100 centipoise (cP), and being substantially water-free.

2. The tissue softener of claim 1, wherein the softening agent is a non-ionic compound, a cationic compound, a silicone compound, or any combination thereof.

3. The tissue softener of claim 2, wherein the cationic compound is a quaternary ammonium compound, an imidazoline compound, an imidazolinium compound, or any combination thereof.

4. The tissue softener of claim 2, wherein the non-ionic compound is a mixture of a sorbitan oleate and ethoxylated alkyl amines.

5. The tissue softener of claim 2, wherein the cationic compound is a mixture of an imidazolinium compound and an anionic silicone.

6. The tissue softener of claim 1, wherein the viscosity modifying agent is a surfactant, an emollient, a silicone compound, or any combination thereof.

7. The tissue softener of claim 6, wherein the surfactant is an anionic surfactant, a cationic surfactant, a non-ionic surfactant, or any combination thereof.

8. The tissue softener of claim 6, wherein the emollient is an oil, an ester, a liquid fatty acid, a polyol, or any combination thereof.

9. The tissue softener of claim 6, wherein the silicone compound is a dimethicone copolyol, a silicone phosphate, a complex of a silicone quaternary compound and an anionic silicone compound, a silicone polyether ester and fatty acid carboxylate, or any combination thereof.

10. The tissue softener of claim 6, wherein the surfactant is a secondary alcohol ethoxylate, polysorbate 20, or a combination thereof.

11. The tissue softener of claim 6, wherein the emollient is isopropyl myristate.

12. The tissue softener of claim 1, wherein the viscosity modifying agent is present in an amount in a range between about 5 and about 90 weight % (wt. %) based on the total weight of the tissue softener.

13. The tissue softener of claim 1, wherein the softening agent is present in an amount in a range between about 10 and about 95 wt. % based on the total weight of the tissue softener.

14. The tissue softener of claim 1, wherein water is present in an amount less than 5 wt. %. based on the total weight of the tissue softener.

15. The tissue softener of claim 1, wherein the viscosity is in a range between about 100 and about 1500 cP.

16. A tissue comprising the tissue softener of claim 1 disposed onto a surface of the tissue.

17. The tissue softener of claim 1, further comprising a skin care additive.

18. The tissue softener of claim 17, wherein the skin care additive is a soothing additive, a cooling additive, a warming additive, an antimicrobial additive, a skin pH balancing additive, a deodorant additive, an oil, or any combination thereof.

19. The tissue softener of claim 18, wherein the oil is coconut oil.

20. A method of making a tissue, the method comprising:
depositing a tissue softener directly onto a surface of a substrate comprising cellulosic fibers;
the tissue softener comprises a softening agent and a viscosity modifying agent, has a viscosity of at least 100 cP, and is substantially water-free.

21. The method of claim 20, wherein depositing is spraying, printing, roll coating, or a combination thereof.

22. The method of claim 20, wherein the tissue softener is mixed with air and deposited onto the surface of the substrate with air atomizing nozzles, and optionally, using vacuum to control air flow in the substrate.

23. The method of claim 20, wherein the % retention of the tissue softener on the surface of the substrate is at least 40% of the total weight deposited onto the surface.

24. The method of claim 20, wherein the substrate is dry.

25. The method of claim 20, further comprising drying the substrate after depositing the tissue softener onto the substrate.

26. The method of claim 20, wherein the viscosity modifying agent is a surfactant, an emollient, a silicone compound, or any combination thereof.

27. The method of claim 26, wherein the surfactant is an anionic surfactant, a cationic surfactant, a non-ionic surfactant, or any combination thereof.

28. The method of claim 20, wherein the viscosity modifying agent is present in an amount in a range between about 5 and about 90 wt. % based on the total weight of the tissue softener.

29. The method of claim 20, wherein the softening agent is present in an amount in a range between about 10 and about 95 wt. % based on the total weight of the tissue softener.

30. The method of claim 20, wherein the softening agent is a non-ionic compound, a cationic compound, a silicone compound, or any combination thereof.

31. The method of claim 30, wherein the cationic compound is a quaternary ammonium compound, an imidazoline compound, an imidazolinium compound, or any combination thereof.

32. The method of claim 20, wherein the viscosity is in a range from about 100 to about 4000 cP.

33. The method of claim 20, wherein water is present in an amount less than 5 wt. % based on the total weight of the tissue softener.

34. The method of claim 20, wherein the tissue softener is deposited onto the surface of the substrate at an add-on level in a range from about 0.025% to about 20% by weight of tissue.

35. A method of making a tissue, the method comprising:
depositing a tissue softener onto a wet surface of a substrate comprising cellulosic fibers;
the tissue softener comprises a softening agent and a viscosity modifying agent, has a viscosity of at least 100 cP, and is substantially water-free.

36. The method of claim 35, further comprising drying the substrate after depositing the tissue softener on the substrate.

37. The method of claim 35, wherein depositing is spraying with air atomizing nozzles or ultrasonic spraying.

38. The method of claim 35, wherein water is present in the softener in an amount less than 5 wt. % based on the total weight of the tissue softener.

39. The method of claim 35, wherein the softening agent is a non-ionic compound, a cationic compound, a silicone compound, or any combination thereof.

40. The method of claim 39, wherein the cationic compound is a quaternary ammonium compound, an imidazoline compound, an imidazolinium compound, or any combination thereof.

41. The method of claim 35, wherein the viscosity modifying agent is a surfactant, an emollient, a silicone compound, or any combination thereof.

42. The method of claim 41, wherein the surfactant is an anionic surfactant, a cationic surfactant, a non-ionic surfactant, or any combination thereof.

43. The method of claim 41, wherein the emollient is an oil, an ester, a liquid fatty acid, a polyol, or any combination thereof.

44. The method of claim 41, wherein the silicone compound is a dimethicone copolyol, a silicone phosphate, a complex of a silicone quaternary compound and an anionic silicone compound, a silicone polyether ester and fatty acid carboxylate, or any combination thereof.

45. The method of claim 35, wherein the viscosity modifying agent is present in an amount in a range from about 5 to about 90 wt. % based on the total weight of the tissue softener.

46. The method of claim 35, wherein the softening agent is present in an amount in a range from about 10 to about 95 wt. % based on the total weight of the tissue softener.

47. The method of claim 35, wherein the viscosity is in a range from about 100 to about 4000 cP.

48. The method of claim 35, wherein the tissue softener forms an emulsion on contact with the wet surface.

49. A method of making a tissue, the method comprising:
depositing a tissue softener onto a surface and transferring a substrate comprising cellulosic fibers onto the tissue softener on the surface;
the tissue softener comprises a softening agent and a viscosity modifying agent, has a viscosity of at least 100 cP, and is substantially water-free.

50. The method of claim 49, wherein the surface is a roll, a fabric, a belt, or any combination thereof.

51. The method of claim 49, wherein water is present in the tissue softener in an amount less than 5 wt. % based on the total weight of the tissue softener.

52. The method of claim 49, wherein the softening agent is a non-ionic compound, a cationic compound, a silicone compound, or any combination thereof.

53. The method of claim 52, wherein the cationic compound is a quaternary ammonium compound, an imidazoline compound, an imidazolinium compound, or any combination thereof.

54. The method of claim 49, wherein the viscosity modifying agent is a surfactant, an emollient, a silicone compound, or any combination thereof.

55. The method of claim 54, wherein the emollient is an oil, an ester, a liquid fatty acid, a polyol, or any combination thereof.

56. The method of claim 54, wherein the silicone compound is a dimethicone copolyol, a silicone phosphate, a complex of a silicone quaternary compound and an anionic silicone compound, a silicone polyether ester and fatty acid carboxylate, or any combination thereof.

57. The method of claim 49, wherein the viscosity modifying agent is present in an amount in a range from about 5 to about 90 wt. % based on the total weight of the tissue softener.

58. The method of claim 49, wherein the softening agent is present in an amount in a range from about 10 to about 95 wt. % based on the total weight of the tissue softener.

59. The method of claim 49, wherein the viscosity is in a range from about 100 to about 4000 cP.
